(19) United States
(12) Patent Application Publication
(10) Pub. No.: US 2026/0024514 A1
(43) Pub. Date: Jan. 22, 2026

(54) SERVER DEVICE, METHOD, AND RECORDING MEDIUM

(71) Applicant: CASIO COMPUTER CO., LTD., Tokyo (JP)

(72) Inventor: Ryohei KAWADA, Tokyo (JP)

(73) Assignee: CASIO COMPUTER CO., LTD., Tokyo (JP)

(21) Appl. No.: 19/274,019

(22) Filed: Jul. 18, 2025

(30) Foreign Application Priority Data
Jul. 19, 2024 (JP) 2024-115583

(51) Int. Cl. G10H 1/00; H04N 21/81

(52) U.S. Cl. CPC G10H 1/0008; G10H 2210/091; H04N 21/8133

(57) ABSTRACT

A server device includes a processor. The processor: acquires, from a first electronic device, performance information including moving image information or audio information of performance and setting information of at least one piece of use equipment used in the performance, and transmits, to a second electronic device different from the first electronic device, the performance information according to an instruction from the second electronic device.

### CROSS-REFERENCE TO RELATED APPLICATIONS

This application claims priority to and the benefit of Japanese Patent Application No. 2024-115583 filed on Jul. 19, 2024. The entire specification, claims, and drawings of Japanese Patent Application No. 2024-115583 are incorporated herein by reference.

### TECHNICAL FIELD

The present disclosure relates to a server device, a method, and a recording medium.

### BACKGROUND

When a value of a parameter is changed in equipment such as a musical instrument or an effector, a tone or an acoustic effect of a musical sound (output sound) to be emitted changes. For example, in order to reproduce the output sound of a favorite artist, some people who enjoy playing a musical instrument investigate the use equipment and the playing method.

By setting the equipment to the same setting as the artist, the musical sound can be brought close to the output sound of the artist. JP 2015-32949 A describes that setting information to be output to an amplifier device of another person can be shared.

### SUMMARY

A server device according to an embodiment of the present disclosure includes a processor, wherein the processor: acquires, from a first electronic device, performance information including moving image information or audio information of performance and setting information of at least one piece of use equipment used in the performance, and transmits, to a second electronic device different from the first electronic device, the performance information according to an instruction from the second electronic device.

### BRIEF DESCRIPTION OF THE DRAWINGS

FIG. 1 is a block diagram illustrating a configuration of a setting information sharing system according to one embodiment of the present disclosure;

FIG. 2 is a block diagram illustrating configurations of a server and a client according to one embodiment of the present disclosure;

FIG. 3 is a diagram illustrating an outline of the setting information sharing system according to one embodiment of the present disclosure;

FIG. 4 is a diagram illustrating an example of a screen displayed on an application operated by a player according to one embodiment of the present disclosure;

FIG. 5 is a sequence diagram illustrating an example of a flow in which a supplier uploads content to a server in one embodiment of the present disclosure;

FIG. 6 is a sequence diagram illustrating an example of a flow until a player browses or views content in one embodiment of the present disclosure;

FIG. 7 is a sequence diagram illustrating an example of the flow until the player browses or views content in one embodiment of the present disclosure; and

FIG. 8 is a diagram illustrating an example of a screen displayed on an application operated by a player according to another embodiment of the present disclosure.

### DETAILED DESCRIPTION

The following description relates to a server device, a method, and a program according to one embodiment of the present disclosure. Common or corresponding elements are denoted by the same or similar reference signs, and redundant description is appropriately simplified or omitted.

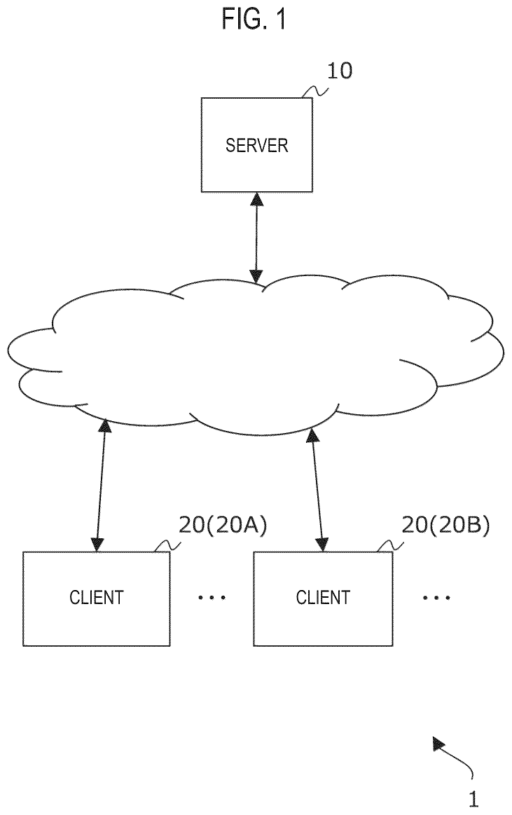

As illustrated in FIG. 1, a setting information sharing system 1 according to one embodiment of the present disclosure includes a server 10 and a client 20. The server 10 and the client 20 are communicably connected to each other via the Internet network. A plurality of clients 20 are connected to the server 10 so as to be able to communicate with each other. In FIG. 1, for convenience, only two clients 20A and 20B among the plurality of clients 20 connectable to the server 10 are illustrated.

The server 10 is an example of a server device and an example of a computer. The server 10 is a general-purpose device.

The client 20 is an example of an electronic device. More specifically, in the example of FIG. 1, the client 20A is an example of a first electronic device. The client 20B is an example of a second electronic device. The client 20 is a general-purpose device, and is, for example, a smartphone, a tablet terminal, or a personal computer (PC). For example, the smartphone can operate as the client 20 by downloading and installing an application that executes the client processing according to one embodiment of the present disclosure from an app store. In this case, for example, the user can operate the client 20 by performing a touch operation on a graphical user interface (GUI) screen on which various components are laid out. In the case of a PC, a web browser connected to the server 10 can operate as the client 20.

Note that any reference to elements using designations such as “first”, “second”, and the like as used in the present disclosure does not generally limit an amount or order of those elements. These designations are used for convenience to distinguish between two or more elements. Therefore, for example, reference to first and second elements does not mean that only the two elements may be adopted, the first element must precede the second element, or the like.

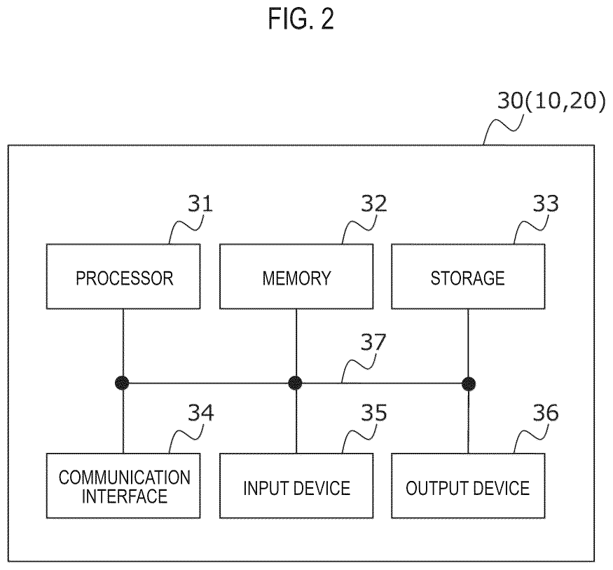

As illustrated in FIG. 2, the server 10 and the client 20, which are general-purpose devices, include a processor 31, a memory 32, a storage 33, a communication interface 34, an input device 35, and an output device 36. Each unit of the server 10 and the client 20 is connected via a bus 37. In the description of FIG. 2, the server 10 and the client 20 are collectively referred to as “information processing apparatus 30”. Note that FIG. 2 merely illustrates an example of the configuration of the information processing apparatus 30. The information processing apparatus 30 may include other elements not illustrated in FIG. 2. The information processing apparatus 30 may be configured not to include some elements illustrated in FIG. 2.

The processor 31 reads a program and data stored in the storage 33. The memory 32 is, for example, a random access memory (RAM). The processor 31 comprehensively controls the information processing apparatus 30 by using the memory 32 as a work area.

The processor 31 is, for example, a single processor or a multiprocessor, and includes at least one processor. In the case of a configuration including a plurality of processors, the processor 31 may be packaged as a single device, or may be configured by a plurality of devices physically separated in the information processing apparatus 30. The processor 31 may be referred to as, for example, a controller, a central processing unit (CPU), a micro processor unit (MPU), or a micro controller unit (MCU).

The storage 33 is, for example, a nonvolatile semiconductor memory such as a flash memory, an erasable programmable ROM (EPROM), or an electrically erasable programmable ROM (EEPROM), a hard disk drive (HDD), or a solid state drive (SSD).

The storage 33 stores various programs and various data. For example, in the server 10, the processor 31 executes a program stored in the storage 33, whereby various types of processing (such as content management described later) according to one embodiment of the present disclosure are executed. For example, in the client 20, the processor 31 executes a program stored in the storage 33, whereby various types of processing (upload, download, streaming reproduction, and the like of content to be described later) according to one embodiment of the present disclosure are executed.

The communication interface 34 is a communication interface with an external device. The server 10 is communicably connected to the client 20 via the communication interface 34. The client 20 is communicably connected to the server 10 via the communication interface 34.

The input device 35 includes, for example, a touch panel, an operation button, a microphone, a camera, a sensor, and the like. The input device 35 may include a keyboard, a mouse, and the like. The output device 36 includes a display, a speaker, and the like. The display may be a touch panel display. The display is, for example, a liquid crystal display (LCD) or an organic electro luminescence (EL) display.

As described above, for example, in order to reproduce the output sound of a favorite artist, some users who enjoy playing a musical instrument look at various media (magazines, social networking service (SNS), etc.) and investigate the use equipment, the playing method, and the setting of the equipment. However, the setting of the equipment is hardly specifically described in these media.

In other words, even when various media are investigated, it is difficult for the user to know specific settings and playing methods of equipment performed by others such as artists. The sound production (output sound) may be determined not only by at least one piece of equipment and setting information of the equipment but also by a combination of a plurality of pieces of equipment and a combination of setting information of each piece of equipment. Therefore, for example, the user performs trial and error of setting of the equipment so as to output the same sound while listening to the music. However, in such a method, it takes time to make the sound production or it takes a purchase cost of unnecessary equipment.

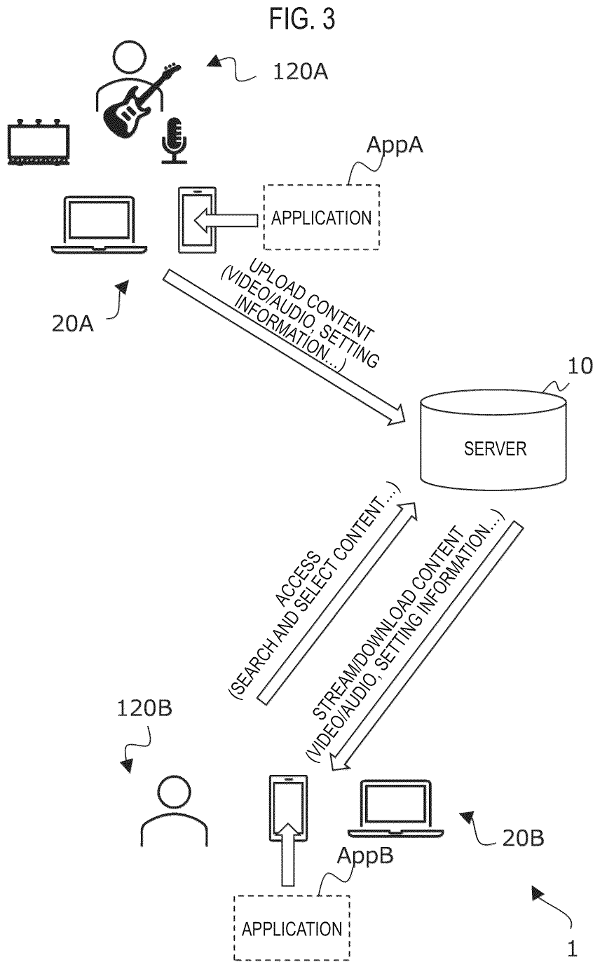

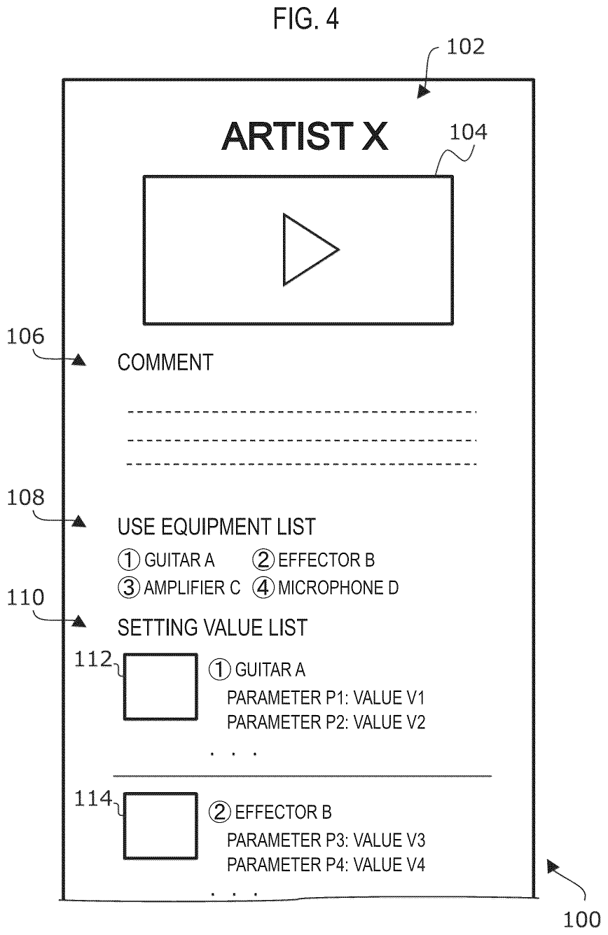

Therefore, in the present embodiment, a mechanism (setting information sharing system 1) in which the user can easily know the setting information of the equipment is introduced. An outline of the setting information sharing system 1 will be described with reference to FIGS. 3 and 4.

A reference numeral 120A denotes a user (supplier) of the client 20A which is an example of the first electronic device. The supplier 120A is a side that provides content (an example of performance information), and is, for example, a professional artist who performs music activities or a general user who likes music. The supplier 120A may be, for example, a business operator that operates the setting information sharing system 1.

For example, the supplier 120A can access the server 10 by activating a dedicated application AppA installed in a smartphone that is an example of the client 20A. For example, the supplier 120A can access the server 10 by operating a web browser of a notebook PC which is an example of the client 20A. Hereinafter, a case where the client 20A is a smartphone will be described.

The supplier 120A films or records the performance of the supplier using the client 20A and other imaging equipment. The supplier 120A can create content by performing a touch operation on the GUI screen provided by the application AppA. Specifically, the supplier 120A performs a registration operation of a recorded performance video, a captured image, a recorded performance audio, and the like on the GUI screen. In addition, the supplier 120A performs input operation of information (product names of guitar, effector, amplifier, microphone, and the like) of the use equipment for the performance, setting information (value of parameter set in use equipment, that is, setting value) of the use equipment, a title of the content, a comment, and the like. The comment is an outline description of content, an introduction of equipment, a review, a description of a music playing method, and the like.

That is, the content provided by the supplier 120A includes a title, a comment, a performance video or a performance audio, information of the use equipment, and setting information thereof. When the supplier 120A touches the upload button on the GUI screen, the content is uploaded to the server 10. Note that the above is an example of information included in content. The content may include other information.

The server 10 provides a service for distributing the uploaded content. The server 10 manages content so that the player 120B can access the content. The player 120B is a user of the client 20B which is an example of the second electronic device. The player 120B is a side on which content is browsed and viewed, and is, for example, a general user who likes music.

For example, the player 120B can access the server 10 by activating a dedicated application AppB installed in a smartphone which is an example of the client 20B. For example, the player 120B can access the server 10 by operating a web browser of a notebook PC which is an example of the client 20B. Hereinafter, a case where the client 20B is a smartphone will be described.

The applications AppA and AppB are the same application, and can create, upload, download, and streaming-reproduce content. The application AppA may be an application that can only create and upload content. The application AppB may be an application that can only download and streaming-reproduce content.

The player 120B activates the application AppB to access the server 10, and can search, browse, and view content. The player 120B can stream and reproduce the performance video and the performance audio embedded in the selected content on the application AppB, and browse the use equipment and its setting information on the application AppB. The player 120B can also store the use equipment and its setting information in the storage 33 of the client 20B.

That is, the server 10 operating as the server device acquires content (an example of performance information) including the performance video or the performance audio (example of moving image information and audio information of performance) and setting information of at least one piece of use equipment for performance from the client 20A which is an example of the first electronic device. The server 10 transmits content according to an instruction from the client 20B (an example of the second electronic device different from the first electronic device) to the client 20B. The setting information of the at least one piece of equipment includes the parameter value (setting value) set by the at least one piece of equipment in performance by the supplier 120A (an example of the user of the first electronic device). The performance video and the performance audio include the moving image information and audio information of performance recorded when the supplier 120A performs, respectively.

The application screen 100 displayed on the application AppB being executed in the client 20B will be described with reference to FIG. 4. The application screen 100 is an example of a screen displayed on the application AppB. On the application screen 100, for example, content of the supplier 120A is displayed. A reference numeral 102 indicates a title included in the content. A reference numeral 104 indicates a performance video embedded in the content. A reference numeral 106 indicates a comment related to the content by the supplier 120A. A reference numeral 108 indicates a list of equipment used for performance. Reference numeral 110 indicates values (setting values) of various parameters of equipment used for performance.

For example, the player 120B searches for a favorite artist X (supplier 120A) on the application AppB, and selects one from the searched content list. As a result, the application screen 100 illustrated in FIG. 4 is displayed on the application AppB.

The service by the server 10 is provided as, for example, a subscription service. Therefore, the content includes pay content and free content. A pay member can browse or view all content provided by the subscription service, for example. The pay member can use, for example, a richer GUI with an extended search function on the application AppB. The pay member can register favorite content without limitation on the application AppB, for example.

Note that there may be content that cannot be browsed or viewed only with the usage fee of the subscription service. For example, there may be purchase type content.

Meanwhile, the free member can browse or view only some content (such as copyright free content) provided by the subscription service, for example. The free member can use only a poor GUI with a limited search function as compared with the pay member. For example, the free member has a limit on the number of favorite contents that can be registered on the application AppB.

The player 120B can grasp the outline of the content by browsing the title 102 and the comment 106, for example. The player 120B can grasp the equipment (in the example of FIG. 4, guitar A, effector B, amplifier C, and microphone D are illustrated) used for the performance by the supplier 120A by checking a use equipment list 108.

In a setting value list 110, an image, a product name, a parameter, and a setting value thereof are displayed for each piece of use equipment for performance by the supplier 120A. In FIG. 4, a reference numeral 112 denotes an image of the guitar A. A reference numeral 114 denotes an image of the effector B. In FIG. 4, parameters P1, P2 are, for example, a sound volume and a pickup height (front, center, rear), respectively. The values V1 and V2 are the sound volume and the pickup height set by the supplier 120A with the guitar A at the time of performance, respectively. The parameter to be set is not limited to the sound volume and the pickup height. The parameter to be set may be a tone, the presence or absence of a tremolo arm, or the like instead of or in addition to the sound volume and the height of the pickup. The parameters P3 and P4 are, for example, the sound volume and gain (distortion), respectively. The values V3 and V4 are values of the sound volume and the gain (distortion) set by the effector B at the time of performance by the supplier 120A. The parameter to be set is not limited to the sound volume and the gain (distortion). The parameter to be set may be various effect levels such as tone, low, mid, high, and coreless reverb delay instead of or in addition to the sound volume and the gain (distortion).

By checking the setting value list 110, the player 120B can accurately and quickly grasp the setting value of each piece of equipment used for performance by the supplier 120A. The player 120B can check an actual performance or a specific playing method performed in the equipment settings indicated in the setting value list 110 by streaming-reproducing the performance video 104 (“performance audio” may be used instead of the “performance video”). The player 120B who wants to reproduce the performance of the supplier 120A can rent or purchase the equipment listed in the use equipment list 108, for example. The player 120B can set equipment while checking the setting value list 110. In the case of the digital type equipment, the player 120B can directly import the setting value from the application AppB to the equipment.

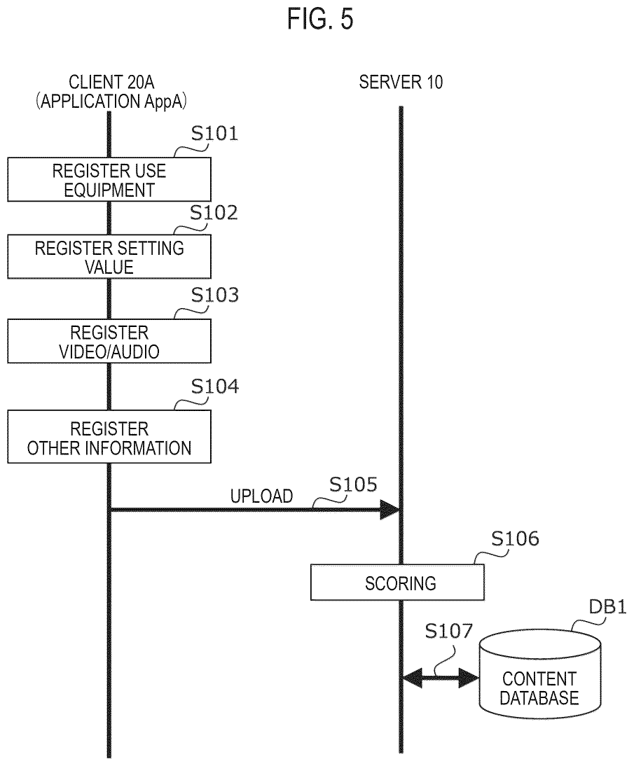

In one embodiment of the present disclosure, an example of a flow in which the supplier 120A uploads content to the server 10 will be described with reference to a sequence diagram of FIG. 5. For example, when the supplier 120A operates the application AppA to display a content registration screen, the execution of the processing illustrated in FIG. 5 is started.

Note that the order of each step of the sequence shown in the embodiment of the present disclosure may be changed within a range without inconsistency. For example, in the embodiment of the present disclosure, the processing including various Steps is presented using exemplary order, but the embodiment of the present disclosure is not limited to this presented order. Furthermore, each step of the sequence shown in the embodiment of the present disclosure may be executed in parallel or in parallel within a range without contradiction.

As illustrated in FIG. 5, the use equipment is registered in the client 20A (Step S101). For example, the supplier 120A operates the application AppA to manually input and register the product name of each use equipment in a form displayed on the GUI screen.

The method of registering the product name of each use equipment is not limited to manual input. For example, the application AppA is connected to a library that collects product names of equipment. The supplier 120A can select and register a corresponding product name from the equipment registered in the library. In this case, the supplier 120A can save manual input.

Such a library may be held by the server 10 or may be held by an external server. The library may be stored in a local folder of the client 20A at the time of installation or update of the application AppA.

The supplier 120A can also register the use equipment by using the image of the use equipment. The image of the use equipment is captured by the client 20A, for example. In this case, for example, the application AppA uploads the image of the use equipment to the external server via the server 10. The external server performs image analysis using artificial intelligence (AI) on the uploaded image of the use equipment. The external server acquires the corresponding product name based on the analysis result and transmits the product name to the client 20A. The application AppA registers the product name received from the external server as the product name of the use equipment. Also in this case, the supplier 120A can save manual input.

The setting value of the use equipment is registered in the client 20A (Step S102). For example, the supplier 120A operates the application AppA to manually input and register various parameters of the use equipment and setting values thereof in a form displayed on the GUI screen.

The method of registering the setting value of each use equipment is not limited to manual input. For example, characters indicating parameters such as “VOLUME” are printed around knobs (knobs) provided on the effectors. When the supplier 120A photographs the knob with the camera of the client 20A, the application AppA calls an optical character reader (OCR) function of the camera to detect a character indicating a parameter such as “VOLUME”.

In addition, the application AppA uploads the image of the knob to an external server. The external server performs image analysis by AI on the uploaded image of the knob. In the image analysis, the setting value is estimated from the adjustment position of the knob appearing in the image. The external server transmits the analyzed setting value to the client 20A. The application AppA registers the parameter indicated by the character detected by the OCR, and registers the setting value received from the external server as the setting value of the parameter. Also in this case, the supplier 120A can save manual input.

The client 20A registers the performance video and the performance audio (Step S103). For example, the supplier 120A operates the application AppA to associate the performance video file and the performance audio file with the content.

Other information is registered in the client 20A (Step S104). For example, the supplier 120A operates the application AppA to manually input and register information such as a title, a comment, and a search tag in a form displayed on the GUI screen.

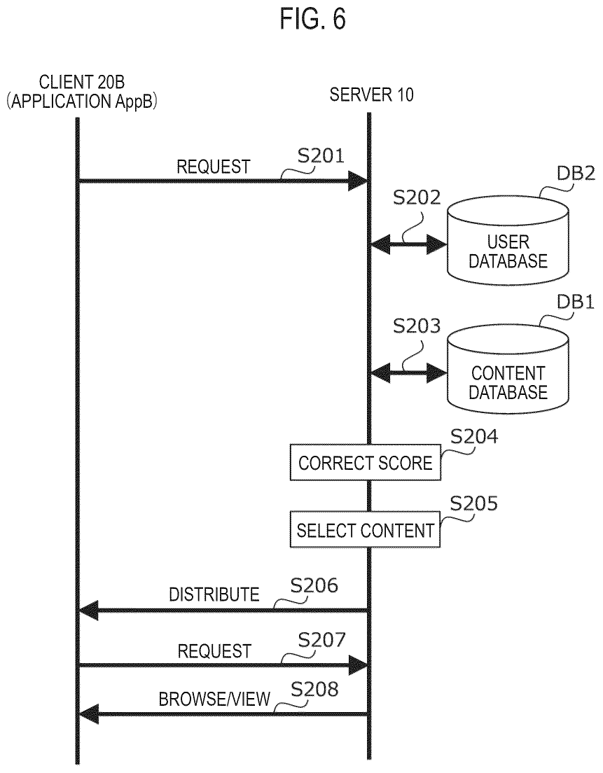

The supplier 120A operates the application AppA to upload content including each piece of information registered in Steps S101 to S104 to the server 10 (Step S105). For example, user information (identification information of the supplier 120A) is attached to the uploaded content as meta information. The identification information of the supplier 120A is registered in a user database DB2 (see FIG. 6). Therefore, the server 10 can manage the uploaded content as the content of the supplier 120A.

The server 10 scores the uploaded content (Step S106). For example, a content in which information is registered in many items (title, comment, performance video, performance audio, use equipment, setting value, etc.) is given a higher score (an example of the evaluation value of the performance information). In other words, the richer content has a higher score.

The server 10 may appropriately update the score of the content added at the time of upload. For example, the server 10 periodically checks a log related to content. The server 10 calculates, for example, the number of accesses and the number of purchases of content in the last three months based on the checked log. The server 10 increases the score of the content as the calculated number of accesses and the number of purchases are larger. Furthermore, the server 10 may periodically update the score according to the freshness of the content. Exemplarily, the server 10 lowers the score of the content as time passes after the content is uploaded.

The server 10 creates a new record, and registers the uploaded content, the score, and the identification information of the supplier 120A in the content database DB1 in association with each other (Step S107). The server 10 can manage the uploaded content as the content of the supplier 120A by linking the content database DB1 and the user database DB2. Note that information such as the number of accesses and the number of purchases of content is sequentially added to the created new record. The content database DB1 may be held by the server 10 or may be held by an external server.

In one embodiment of the present disclosure, an example of a flow until the player 120B browses or views the content will be described using the sequence diagram of FIG. 6. For example, when the player 120B activates the application AppB, execution of the processing illustrated in FIG. 6 is started.

The activated application AppB requests the server 10 for connection or the like (Step S201). The request includes user information (identification information of the player 120B) of the player 120B. The server 10 that has received the request performs various exchanges with the user database DB2 (Step S202).

Various types of user information such as user identification information, account information, a member type (pay member or free member), a name, individual setting (for example, favorite artist, music, equipment, and the like), and a search history are registered in the user database DB2. For example, in Step S202, the server 10 inquires of the user database DB2 whether or not the player 120B is the pay member. In addition, the server 10 acquires user information such as individual settings and a search history of the player 120B from the user database DB2.

The server 10 accesses the content database DB1 to correct the score, and selects the content based on the corrected score (Steps S203 to S205). For example, the server 10 performs multivariate analysis based on user information such as individual settings and a search history of the player 120B acquired from the user database DB2, and analyzes the preference of the player 120B. The server 10 corrects the score of each content by applying a coefficient corresponding to the degree of correlation such that the content having a higher degree of correlation with the analyzed preference has a higher score. Note that multivariate analysis and content correction processing have a large processing load. Therefore, the processing may be executed by an external server.

For example, the server 10 distributes content having the top 3 corrected scores to the client 20A by feed (Step S206). With such a recommendation function of the server 10, a thumbnail, a digest image, or the like of content that suits the preference of the player 120B flows on the application AppB.

When the player 120B touches the content flowing by the recommendation function, the application AppB requests the content from the server 10 (Step S207). When the server 10 responds to the request, the player 120B can browse or view the content on the application AppB (Step S208). For example, the player 120B can give a review to the browsed or viewed content.

In this manner, the server 10 scores (calculates the evaluation value) the content (an example of the performance information) acquired from the client 20A (an example of the first electronic device). The server 10 selects content based on the calculated score, and transmits the selected content to the client 20B (an example of the second electronic device). In addition, the server 10 corrects the score based on the information (for example, the information regarding the preference of the player 120B) regarding the player 120B (an example of the user of the second electronic device). The server 10 selects content based on the corrected score and transmits the selected content to the client 20B.

For example, the business operator operating the setting information sharing system 1 pays a consideration (for example, a financial consideration) corresponding to the number of accesses and the number of purchases of the content to the content provider such as the supplier 120A. The supplier 120A can obtain the consideration and the player 120B can easily try the same equipment setting as the favorite artist. The business operator can obtain, for example, a usage fee of the subscription service and sales of the purchase type content. When advertising is distributed on the application AppB, the business operator can also obtain advertisement revenue. In this case, an advertisement block function may be added as one of the leads to the pay member.

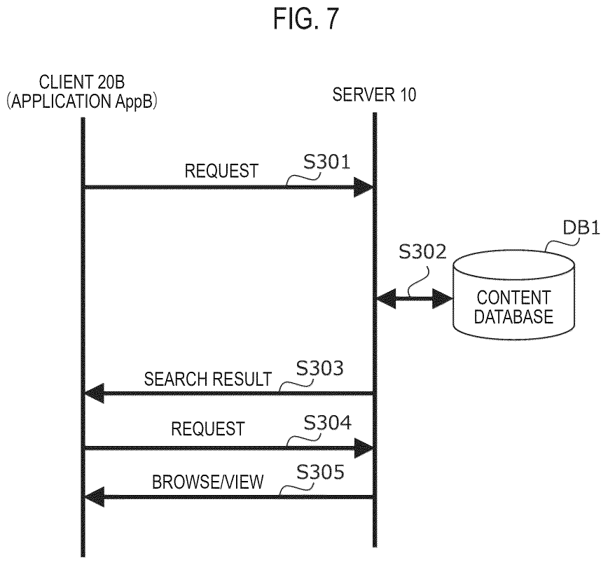

In one embodiment of the present disclosure, an example of a flow until the player 120B browses or views the content will be described using the sequence diagram of FIG. 7. For example, when the player 120B performs a content search operation on the application AppB, execution of the processing illustrated in FIG. 7 is started.

The player 120B inputs a search word such as an artist, music, or equipment on the application AppB, for example. The application AppB transmits a request corresponding to the search word input by the player 120B to the server 10 (Step S301). The server 10 that has received the request accesses the content database DB1 and searches the content database DB1 (Step S302). The server 10 transmits the search result to the client 20B (Step S303).

When the player 120B selects content from the search result, the application AppB requests the content from the server 10 (Step S304). When the server 10 responds to the request, the player 120B can browse or view the content on the application AppB (Step S305). The player 120B can easily select content such as a target artist, music, or equipment to browse or view.

The business operator who operates the setting information sharing system 1 formally recognizes a content provider satisfying a predetermined condition such as being famous or having high sales. The content of the officially approved content provider is marked with an official mark. The player 120B can determine the reliability of the content by using the presence or absence of the official mark as one material. Furthermore, the server 10 may construct a search engine so that content of an officially certified content provider is more likely to be ranked higher in search than content of a content provider who is not officially certified.

According to the above-described embodiment, it is possible to solve the problem that it is generally difficult to know settings of equipment such as a user's favorite artist and a playing method at a user's desired timing.

The above is the description of the exemplary embodiment of the present disclosure. The embodiment of the present disclosure is not limited to that described above, and various modifications can be made within the scope of the technical idea of the present disclosure. For example, the embodiment of the present application also includes contents obtained by appropriately combining the embodiment and the like exemplarily specified in the specification or obvious embodiments and the like.

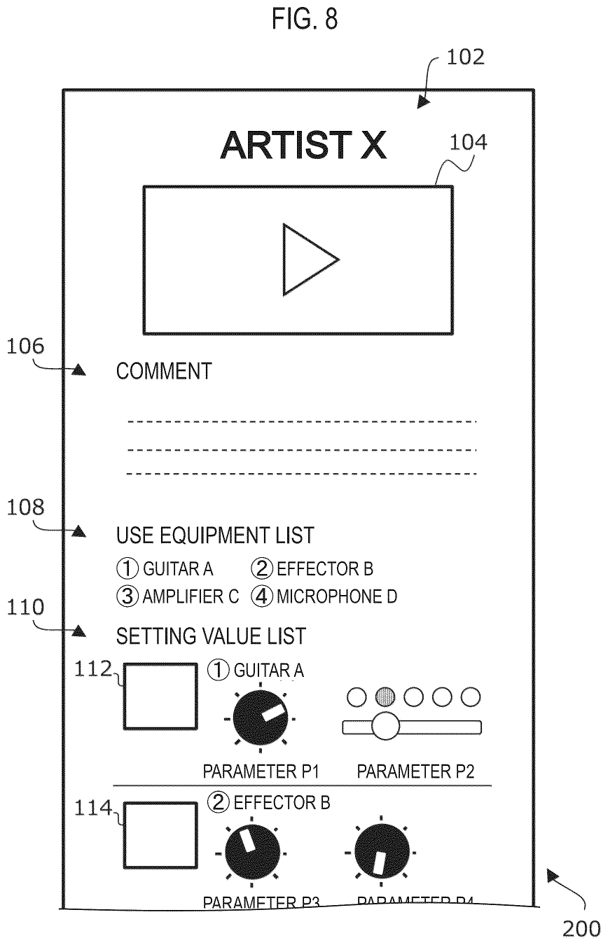

For example, in the above embodiment, as illustrated in the application screen 100 of FIG. 4, the setting value of the use equipment is displayed as text. In another embodiment, as illustrated in an application screen 200 of FIG. 8, the setting values of the use equipment may be displayed as images imitating switches of actual equipment. In this case, the player 120B can more intuitively grasp how to set the equipment.

What is claimed is:

1. A server device comprising a processor, wherein the processor:
acquires, from a first electronic device, performance information including moving image information or audio information of performance and setting information of at least one piece of use equipment used in the performance, and
transmits, to a second electronic device different from the first electronic device, the performance information according to an instruction from the second electronic device.

2. The server device according to claim 1, wherein
the setting information includes a value of a parameter set by the at least one piece of equipment in the performance by a user of the first electronic device.

3. The server device according to claim 1, wherein
the moving image information and the audio information include moving image information and audio information of the performance recorded when a user of the first electronic device performs the performance, respectively.

4. The server device according to claim 1, wherein
the processor:
calculates an evaluation value of the performance information acquired from the first electronic device,
selects the performance information based on the calculated evaluation value, and
transmits the selected performance information to the second electronic device.

5. The server device according to claim 4, wherein
the processor:
corrects the evaluation value based on information regarding a user of the second electronic device,
selects the performance information based on the corrected evaluation value, and
transmits the selected performance information to the second electronic device.

6. A method causing a computer to execute:
acquiring, from a first electronic device, performance information including moving image information or audio information of performance and setting information of at least one piece of use equipment for the performance; and
transmitting, to a second electronic device different from the first electronic device, the performance information according to an instruction from the second electronic device.

7. The method according to claim 6, wherein
the setting information includes a value of a parameter set by the at least one piece of equipment in the performance by a user of the first electronic device.

8. The method according to claim 6, wherein
the moving image information and the audio information include moving image information and audio information of the performance recorded when a user of the first electronic device performs the performance, respectively.

9. The method according to claim 6, further comprising:
calculating an evaluation value of the performance information acquired from the first electronic device, and
selecting the performance information based on the calculated evaluation value, wherein
in the transmitting, the selected performance information is transmitted to the second electronic device.

10. The method according to claim 9, further comprising:
correcting the evaluation value based on information regarding a user of the second electronic device,
selecting the performance information based on the corrected evaluation value, wherein
in the transmitting, the selected performance information is transmitted to the second electronic device.

11. A non-transitory computer-readable recording medium that records a program executable by a computer of a server device, wherein
a processor causes the computer to function as:
acquiring, from a first electronic device, performance information including moving image information or audio information of performance and setting information of at least one piece of use equipment for the performance; and
transmitting, a second electronic device different from the first electronic device, the performance information according to an instruction from the second electronic device.

12. The non-transitory computer-readable recording medium according to claim 11, wherein
the setting information includes a value of a parameter set by the at least one piece of equipment in the performance by a user of the first electronic device.

13. The non-transitory computer-readable recording medium according to claim 11, wherein
the moving image information and the audio information include moving image information and audio information of the performance recorded when a user of the first electronic device performs the performance, respectively.

14. The non-transitory computer-readable recording medium according to claim 11, further comprising:
calculating an evaluation value of the performance information acquired from the first electronic device, and
selecting the performance information based on the calculated evaluation value, wherein
in the transmitting, the selected performance information is transmitted to the second electronic device.

15. The non-transitory computer-readable recording medium according to claim 14, further comprising:
correcting the evaluation value based on information regarding a user of the second electronic device,
selecting the performance information based on the corrected evaluation value, wherein
in the transmitting, the selected performance information is transmitted to the second electronic device.
